(19) United States
(12) Patent Application Publication
(10) Pub. No.: US 2026/0216796 A1
(43) Pub. Date: Jul. 30, 2026

(54) LOCKING CHUCK WITH ANTI-VIBRATION FEATURE

(71) Applicants: Apex Brands, Inc., Apex, NC (US); Jacobs Chuck Manufacturing (Suzhou) Company LTD., Suzhou (CN)

(72) Inventor: Jichun Zhou, Suzhou (CN)

(21) Appl. No.: 19/145,690

(22) PCT Filed: Jan. 10, 2023
(86) PCT No.: PCT/CN2023/071592

§ 371 Date: Jul. 3, 2025

(51) Int. Cl. B23B 31/12

(52) U.S. Cl. CPC B23B 31/123; B23B 2260/114

(57) ABSTRACT

A chuck for use with a power driver may include a plurality of jaws, a body assembly, a nut, a sleeve, and a lock ring. The lock ring may include a lock ring interface configured to, when the lock ring is in an unlocked position, permit rotation of the nut relative to the body assembly in a first rotational direction and also permit rotation of the nut relative to the body assembly in a second rotational direction. The lock ring interface may also be configured to, when in the locked position, prevent rotation of the nut in the second rotational direction and apply an anti-vibration compression force on the sleeve, via a damping member, to increase an engagement force between sleeve and the body assembly to reduce vibration in the chuck when the lock ring is in the locked position.

### TECHNICAL FIELD

Example embodiments generally relate to chucks for use with power drivers including power drills, and more particularly, relate to chucks having features to limit vibrations generated by the rotation of the chuck.

### BACKGROUND

Power drivers with rotating drive spindles are often operably coupled to a chuck that includes an adjustable opening that can clamp onto various working bits, such as drill bits or other tools. These working bits can then be rotated with the chuck by the drive spindle of the power driver to perform various work tasks. Chucks typically employ moveable jaws that are operable to adjust a size of the opening in the chuck for receiving a working bit. In many instances these jaws are held in place while the power driver is in a working mode (e.g., drilling a hole, driving or removing a fastener, etc.) by a nut with a threaded engagement. Therefore, a frictional engagement of the threading with the nut may be the means by which the jaws to remain engaged with the working bit.

In some instances, however, the internal components of the chuck may vibrate due to high-speed rotation caused by the power driver. Such vibration coupled with inertia of rotating chuck can cause the nut and therefore the jaws of the chuck to loosen unintentionally. To prevent this, some chucks employ a locked mode where the chuck is not permitted to rotate in a loosening direction. However, even chucks with a locked mode can suffer from unintended loosening due to inertia and vibration causing the chucks to unintentionally move out of the locked mode. As such, further innovation offering technical solutions that inhibit unintentional movement of chuck components to maintain and control the jaw's clamping forces on the working bit would be beneficial.

### SUMMARY OF SOME EXAMPLES

According to some example embodiments, a chuck for use with a power driver having a rotatable drive spindle is provided. The chuck may comprise a plurality of jaws, and a body assembly configured to rotate with the drive spindle. The plurality of jaws may be configured to rotate with the body assembly about a center axis of the chuck, and the plurality of jaws may also move relative to the body assembly in an opening or closing direction. The chuck may also comprise a nut operably coupled to the jaws such that rotation of the nut relative to the body assembly moves the jaws relative to the body assembly in the opening or closing direction. The chuck may also comprise a sleeve coupled to the nut and the body assembly, and a lock ring operably coupled to the nut and the sleeve and configured to rotate with the nut. The lock ring may comprise a lock ring interface with a damping member. The lock ring interface being configured to, when the lock ring is in an unlocked position relative to the sleeve, permit rotation of the nut relative to the body assembly in a first rotational direction to move the jaws in the closing direction and also permit rotation of the nut relative to the body assembly in a second rotational direction to move the jaws in the opening direction. In this regard, the second rotational direction may be opposite the first rotational direction. Additionally, the lock ring interface being configured to, when the lock ring is in the locked position, permit rotation of the nut relative to the body assembly in the first rotational direction to move the jaws in the closing direction, prevent rotation of the nut relative to the body assembly in the second rotational direction, and apply an anti-vibration compression force by the damping member on the sleeve to increase an engagement force between sleeve and the body assembly to reduce vibration in the chuck when the lock ring is in the locked position.

According to some example embodiments, another chuck is provided. The chuck may comprise a body assembly, and a plurality of jaws. The plurality of jaws may rotate with the body assembly about a center axis of the chuck and may also move relative to the body assembly in an opening or closing direction. The chuck may also comprise a nut operably coupled to the jaws such that rotation of the nut relative to the body assembly moves the jaws relative to the body assembly in the opening or closing direction. The chuck may also comprise a sleeve and a lock ring operably coupled to the nut and the sleeve. The lock ring may be coupled to the nut such that the lock ring and the nut rotate together. The lock ring may be coupled to the sleeve such that the lock ring rotates relative to the sleeve when transitioning between a locked position and an unlocked position. The lock ring may comprise a damping member configured to apply an anti-vibration compression force on the sleeve to increase an engagement force between sleeve and the body assembly to reduce vibration in the chuck when the lock ring is in the locked position. The anti-vibration compression force is not applied when the lock ring is in the unlocked position. When the lock ring is in a locked position, rotation of the nut relative to the body assembly to move the jaws in the opening direction is prevented.

According to some example embodiments, another chuck is provided. The chuck may comprise a body assembly and a plurality of jaws. The plurality of jaws may rotate with the body assembly about a center axis of the chuck. The plurality of jaws may also move relative to the body assembly in an opening or closing direction. The chuck may also comprise a nut operably coupled to the jaws such that rotation of the nut relative to the body assembly moves the jaws relative to the body assembly in the opening or closing direction. The chuck may further comprise a sleeve, and a lock ring operably coupled to the nut and the sleeve. The lock ring may be coupled to the nut such that the lock ring and the nut rotate together. The lock ring may be coupled to the sleeve such that the lock ring rotates relative to the sleeve when transitioning between a locked position and an unlocked position. The lock ring may comprise a ring portion and a damping arm. The ring portion may define a ring portion plane, and the damping arm may from the ring portion at an angle such that an end of the damping arm is out of the ring portion plane. The damping arm may exhibit a damping mechanical bias and the damping arm may be configured to apply an anti-vibration compression force that is directed parallel to the center axis of the chuck, via the damping mechanical bias, on the sleeve to increase an engagement force between internal sleeve and the external sleeve to reduce vibration in the chuck when the lock ring is in the locked position. The anti-vibration compression force is not applied when the lock ring is in the unlocked position. When the lock ring is in a locked position, rotation of the nut relative to the body assembly to move the jaws in the opening direction is prevented.

### BRIEF DESCRIPTION OF THE DRAWINGS

Having thus described some example embodiments in general terms, reference will now be made to the accompanying drawings, which are not necessarily drawn to scale, and wherein:

FIG. 1 illustrates a perspective side view of a chuck in accordance with an example embodiment;

FIG. 2 illustrates an exploded view of a chuck in accordance with an example embodiment;

FIG. 3 illustrates a side view of a chuck with selected external components removed to show the configuration of internal components and defining cross-sections A-A and B-B according to some example embodiments;

FIG. 4 illustrates a side view of a body assembly of a chuck in accordance with an example embodiment;

FIG. 5 illustrates a perspective view of a sleeve in accordance with an example embodiment;

FIG. 6 illustrates a perspective view of an outer sleeve in accordance with an example embodiment;

FIG. 7 illustrates a perspective front view of an inner sleeve in accordance with an example embodiment;

FIG. 8 illustrates a perspective rear view of an inner sleeve in accordance with an example embodiment;

FIG. 9 illustrates a perspective front view of a lock ring in accordance with an example embodiment;

FIG. 10 illustrates a side view of a lock ring in accordance with an example embodiment;

FIG. 11 illustrates a perspective front view of a nut and nut retainer assembly in accordance with an example embodiment;

FIG. 12 illustrates a cross-section view of the chuck in a locked state taken at the plane defined by A-A of FIG. 3 viewed from the rear in accordance with an example embodiment;

FIG. 13 illustrates a partial cross-section view of a chuck in a locked state taken at the plane defined by B-B of FIG. 3 viewed from the front in accordance with an example embodiment;

FIG. 14 illustrates a side view of a chuck with selected external components removed to show a damping member with the chuck in the locked state according to some example embodiments;

FIG. 15 illustrates a zoomed side view of a damping member of the chuck of FIG. 14 in the locked state according to some example embodiments;

FIG. 16 illustrates a partial cross-section view of a chuck in an unlocked state taken at the plane defined by C-C of FIG. 17 viewed from the front in accordance with an example embodiment;

FIG. 17 illustrates a side view of a chuck with selected external components removed to show a damping member with the chuck in the unlocked state according to some example embodiments; and

FIG. 18 illustrates a zoomed side view of a damping member of the chuck of FIG. 17 in the unlocked state according to some example embodiments.

### DETAILED DESCRIPTION OF SOME EXAMPLE EMBODIMENTS

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. As used herein, operable coupling should be understood to relate to direct or indirect connection that, in either case, enables functional interconnection of components that are operably coupled to each other.

As mentioned above, unintended chuck loosening can be caused by high potential energy in the form of inertia and vibrations that occur when a chuck is being rotated by a power driver at high rotational speeds. Some conventional chucks provide some compensation for inertia via chuck locking mechanisms. However, some conventional solutions that only address issues relating to inertia-based loosening may still suffer from issues that arise from vibration issues. In this regard, some inertia-based solutions, including those described herein, are configured to maintain the chuck in a locked state despite being subjected to near-instantaneous forces and torques that arise from sudden stops of a power driver. The power driver spindle is often directed coupled to a body of a chuck, and therefore the body, and components fixedly attached to the body, do not typically contribute to inertia and vibration issues that lead to unintended jaw loosening. Rather, chuck components that can rotate relative to the body are typically the components that cause inertia and vibration issues. In particular, vibrations arising from these components of a chuck can be cause reductions in the frictional forces that would otherwise keep the chuck in a locked state. This can occur because vibrations can overcome the initial starting or static friction between moving components, and starting or static friction is a greater magnitude frictional force than sliding friction (i.e., the frictional forces that are present after starting or static friction is initially overcome). As such, the existence of vibrations within the chuck can reduce the ability to maintain a locked state and can contribute to the technical problem of unintended loosening.

Numerous sources of vibrations can be present within a rotating chuck. Imbalances and loosely coupled components may be common sources. Some risk of vibration exists due to the inclusion of components that allow for any relative movement including desired relative movement. In some instances, relative movement between large and/or heavy components of a chuck can be particularly problematic, such as the sleeve of a chuck. The sleeve is typically a relatively heavy component and the sleeve is generally coupled to many of the components of the chuck that move relative to the body of the chuck and therefore are at risk of contributing to vibrations.

Because the sleeve is the user interface for the chuck, the sleeve is configured to rotate relative to the body to cause the jaws to open and close. Such relative rotation is therefore necessary for bit removal and installation into the jaws. However, once the bit is secured and the chuck is locked, relative movement can be detrimental due to the risk of inertia and vibration that gives rise to unintended loosening of the jaws. It would therefore be beneficial for the sleeve and the other components that can move relative to the body to be forced into close coupling to the body to limit or avoid relative movement while in a locked state. In this way, vibrations caused by the sleeve and caused by components coupled to the sleeve may be reduced or eliminated. As such, technical solutions, such as those described herein, that operate to increase forced engagement between, for example, the body and the sleeve to reduce vibrations when the chuck is in a locked state, but still permit low-friction rotation of the sleeve relative to body when the chuck is in an unlocked state, would be beneficial.

According to some example embodiments, a damping member may be implemented that selectively engages with the sleeve when the chuck is in the locked state to apply an anti-vibration compression force on the sleeve, which forces the sleeve into high-friction engagement with a body assembly to reduce or eliminate vibration in the sleeve. Limiting relative movement between the sleeve and the body assembly is particularly useful when the chuck is in the locked state to prevent unintended transition from the locked state to the unlocked state.

According to some example embodiments, the locked state may be implemented to tighten the jaws of the chuck down onto a bit and to maintain the jaws in continued engagement with the bit during operation. To do so, the chuck, according to some example embodiments, does not permit rotation of the sleeve in the rotational direction that would open the jaws once the chuck is in the locked state, and only permits rotation of the sleeve in the tightening or closing direction, for example, via a ratcheting mechanism when in the locked state. An unlocked state may be implemented during removal and replacement of a bit. As such, the sleeve may be rotated in either direction while in the unlocked state to either open the jaws or close the jaws.

According to some example embodiments, when the sleeve is rotated to close the jaws, a threshold rotational force may be required to continue tightening the jaws onto a bit, and this threshold rotational force may cause a transition of the chuck into the locked state to continue the tightening action. Similarly, in the locked state, according to some example embodiments, the chuck may transition into the unlocked state after a threshold rotational force is applied to loosen the jaws. A more specific description of the operations that occur and the components involved during such state transitions (i.e., locked to unlocked or unlocked to locked) are described in more detail below.

In view of the manner of operation of the chuck in the locked and unlocked states, some example embodiments may operate to reduce vibration, for example, originating from the interface between the sleeve and the body assembly. To do so, some example embodiments may operate to create a selective forced-compression coupling between the sleeve and the nose (as a component of a body assembly) via a damping member that selectively applies an anti-vibration compression force on the sleeve in the direction of the nose (e.g., parallel to an axis of rotation of the chuck). According to some example embodiments, a damping member may be part of a lock ring that includes features for implementing a locked state and an unlocked state for the chuck. The damping member may selectively apply the anti-vibration compression force to cause the sleeve and the body assembly to become more closely coupled when the chuck is in the locked state to reduce the potential for vibration-based unintended unlocking of the chuck. According to some example embodiments, the damping member be mechanically biased and may be moved into a position, when the chuck is in the locked state, where the damping member applies the anti-vibration compression force onto the sleeve. According to some example embodiments, the anti-vibration compression force may be applied on the sleeve in a direction that is parallel with an axis rotation of the chuck to have a forced engagement between the sleeve and a lip of a nose of the chuck that is fixedly attached to the body of the chuck. As such, according to some example embodiments, the anti-vibration compression force may urge the sleeve in a forward direction such that the sleeve applies the anti-vibration compression force on a nose lip of a body assembly as further described below. This forced engagement between the sleeve and the nose lip may create a high-friction coupling that limits relative movement between the nose and the sleeve and inhibits vibrations. Since the nose is fixedly attached to the body, this forced engagement may operate to limit movement of the sleeve relative the body or the body assembly to reduce or elimination associated vibration.

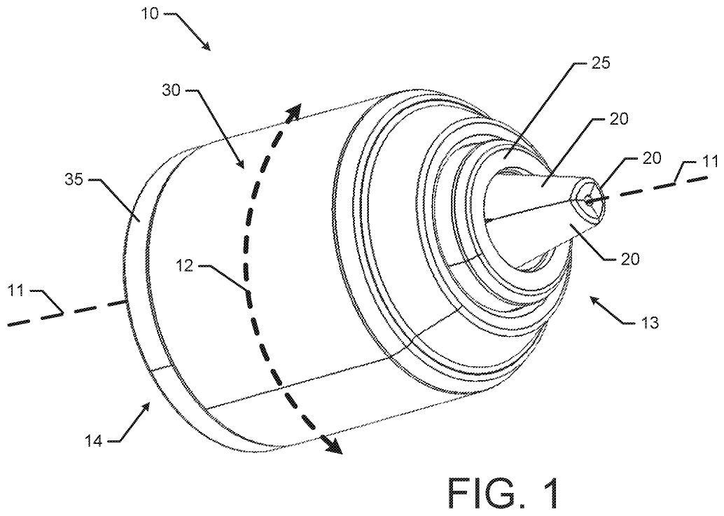

Having described some of the example embodiments and concepts of a lock chuck with an anti-vibration feature, FIG. 1 will now be described which illustrates a perspective side view of a chuck 10 that is configured to implement an anti-vibration feature as described herein. Generally, the chuck 10 may operate to secure a working bit (not shown) in the jaws 20 of the chuck 10, while the chuck 10, and a power driver affixed to the chuck 10, are rotating. The chuck 10 may also operate to permit working bits of varying sizes (e.g., diameters) to be installed and removed by moving the jaws 20 in an opening or closing direction via rotation of the sleeve 30 as indicated by the arrow 12. Further, the chuck 10 may be operably coupled with any type of power driver, including, for example, a pneumatic or electric powered tool (e.g., a drill) configured to rotate a drive spindle that is operably coupled to the chuck 10 at a back or rear end 14 of the chuck 10.

The chuck 10 may define a center axis 11, about which the chuck 10 may rotate. For orientation purposes, the chuck 10 may have a forward end 13 and a rear end 14. The chuck 10 may comprise, among other components, jaws 20, a nose 25, a sleeve 30, and a dust cover 35. According to some example embodiments, the nose 25 may be disposed adjacent to the forward end 13, the dust cover 35 may be disposed adjacent to the back end 14, and the sleeve 30 may be disposed between the nose 25 and the dust cover 35. As further described herein, the jaws 20 may be configured to move or translate within passageways in a body of the chuck 10 in a closing or opening direction to change the size of a jaw opening formed by the forward ends of the jaws 20.

The sleeve 30 may operate as a user interface for opening and closing the jaws 20. According to some example embodiments, the sleeve 30 and the dust cover 35 may be permitted to rotate, while the nose 25 may be rotationally fixed. According to some example embodiments, the sleeve 30 may also be operably coupled to a nut that engages with the jaws 20 in spiral-threaded manner to move the jaws 20 in the opening or closing direction based on the direction of rotation of the sleeve 30, as indicated by arrow 12. As such, rotation of the sleeve 30 may cause the jaws 20 to move such that the jaws 20 clamp onto a working bit or open to permit removal or installation of a working bit.

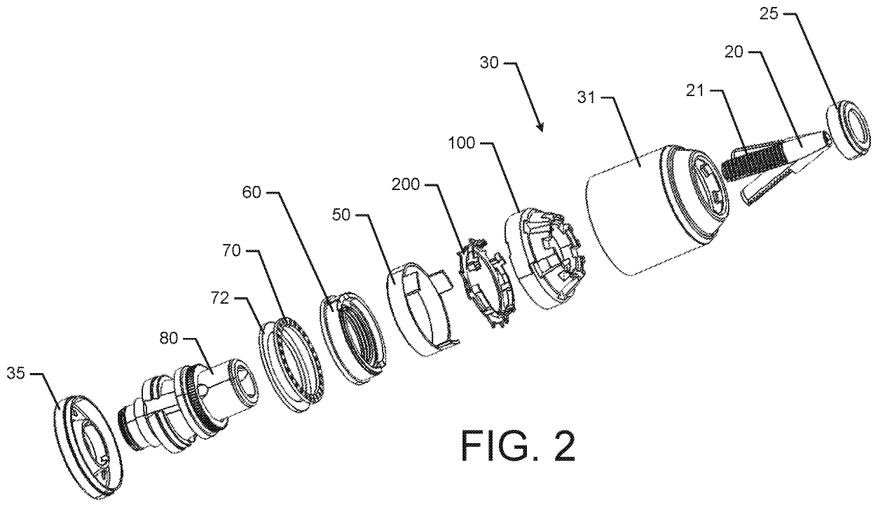

To better understand the components and operation of the chuck 10, FIG. 2 provides an exploded view of some of the various components of the chuck 10, according to some example embodiments. Referring to the order shown in FIG. 2, the chuck 10 may include the a nose 25, jaws 20 with threads 21, a sleeve 30 comprising an outer sleeve 31 and an inner sleeve 100, a lock ring 200, a nut retainer 50, a nut 60, a bearing assembly 70, a washer 72, a body 80, and the dust cover 35. According to some example embodiments, the body 80 may be a core component of the chuck 10 and body 80 may be mechanically coupled to a drive spindle of a power driver to rotate the chuck 10 during operation. According to some example embodiments, the nose 25 may be axially and rotationally fixed to the body 80, while other components may be configured to move relative to the body 80 to perform the various functionalities of the chuck 10. The jaws 20, for example, may rotate with the body 80, but the jaws 20 may also be configured to move with an axial component relative to the body 80 during an opening or closing operation.

According to some example embodiments, the sleeve 30 may comprise an outer sleeve 31 and an inner sleeve 100. While the example embodiments described herein separate the sleeve 30 into components comprising the outer sleeve 31 and the inner sleeve 100, it is understood that example embodiments also cover implementations that comprise an integrated sleeve component with the features of the inner sleeve 100 and the outer sleeve 31. As such, the inner sleeve 100 and the outer sleeve 31 may operate as a unit. The outer sleeve 31 may be coupled to the inner sleeve 100 such that the inner sleeve 100 and the outer sleeve 30 rotate together relative to the body 80. Further, it is understood that references made to the inner sleeve 100 in isolation (particularly with respect to figures where the outer sleeve is omitted) are understood to be referring to the inner sleeve 100 alone, or the sleeve 30.

The lock ring 200 may interface with the inner sleeve 100 as described in further detail below to place the chuck 10 in a locked state and an unlocked state. While the lock ring 200 may rotate relative to the inner sleeve 100 during transitions between a locked position to implement the locked state and the unlocked position to implement the unlocked state, the lock ring 200 may otherwise rotate with the inner sleeve 100.

Additionally, the nut retainer 50 may be coupled to the nut 60 such that the nut retainer 50 rotates with the nut 60. The nut retainer 50 may include features that engage with the lock ring 200 (e.g., lugs) to rotate the lock ring 200 when the nut 60 and the nut retainer 50 rotate relative to the body 80. To reduce the rotational friction of the moving components of the chuck 10, the nut 60 may rest on the bearing assembly 70. The bearing assembly 70 may comprise a holding ring and bearing balls that engage between the nut 60 and the washer 72. The rear surface of the nut 60 and the forward surface of the washer 72 may provide flat engaging surfaces to facilitate low-friction rotation of the nut 60 due to operation of the bearing assembly 70. The washer 72 may rest on a lip of the body 80 and the nose 25 may be affixed to the forward end of the body 80 (e.g., press fit or the like) such that the bearing assembly 70 and the moving components are disposed between the washer 72 and the nose 25.

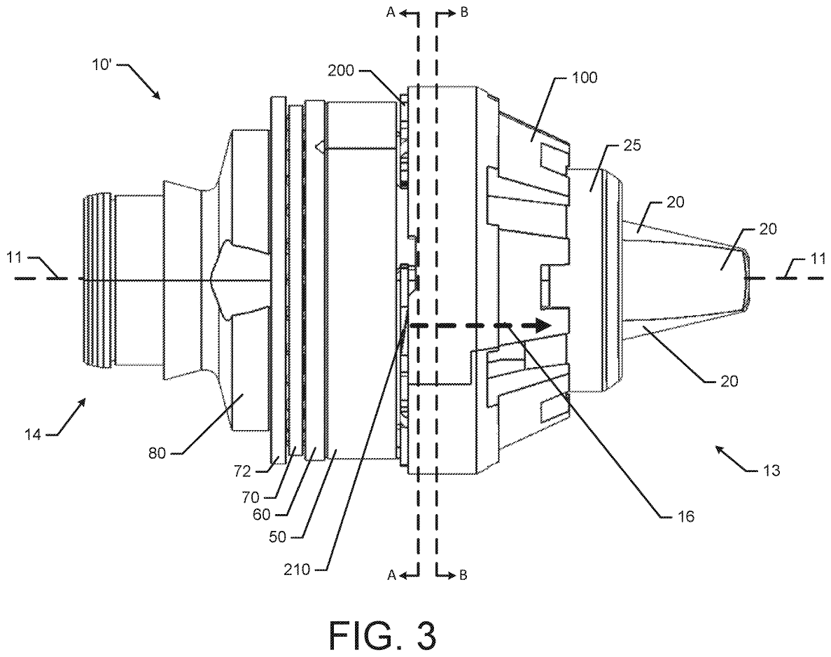

Now referring to FIG. 3, the chuck 10 is shown as chuck 10′ due to the absence of the outer sleeve 30 and the dust cover 35. However, the assembled internal components can be seen, in association with the exploded view of FIG. 2 to facilitate understanding of the internal structure and operation of the chuck 10. Further, FIG. 3 indicates locations of cross-sectional views of the chuck 10′ when in the locked state as further described below.

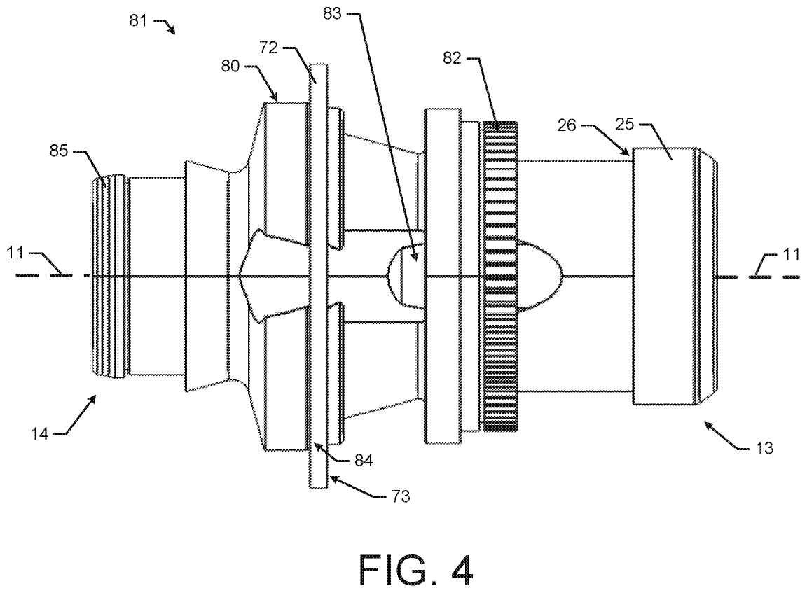

As such, with reference to FIG. 3, a side view of the chuck 10′ is shown. As can be seen, the internal components of the chuck 10 may be disposed between the nose 25 at the forward end 13 and the washer 72 near the rear end 14. In this regard, as further described and shown in FIG. 4, the washer 72 and the nose 25 may be affixed to the body 80 such that the washer 72 and the nose 25 do not move axially (referring to axis 11) relative to body 80. At least the nose 25, according to some example embodiments, may also be affixed to the body 80 such that the nose 25 also does not rotate about the axis 11 relative to the body 80.

As mentioned above, the washer 72 may be secured within a groove of the body 80. Therefore, according to some example embodiments, to assemble the chuck 10′, various components may be stacked onto the washer 72 and the nose 25 may be secured to body 80 to complete the assembly process. Alternatively, the nose 25 may be applied first and the various components may be stacked on the nose 25 and secured in place via installation of the washer 72. The bearing assembly 70 may be disposed on the washer 72 and the nut 60 may be disposed on the bearing assembly 70. The nut retainer 50 may be affixed onto the nut 60, and the lock ring 200 may be coupled to the nut retainer 50 and rest on the front surface of the nut 60. The lock ring 200 may be disposed at least partially within an internal rear side cavity of the inner sleeve 100 to selectively engage with various features disposed with the rear side cavity of the inner sleeve 100. The inner sleeve 100 (and the outer sleeve 31) may be secured in place by the nose 25, which may be affixed to the body 80.

As further described herein, the lock ring 200 may comprise a damping member 210 that, when the lock ring 200 is in locked position as shown in FIG. 3, the damping member 210 applies an anti-vibration compression force on the sleeve 30, here shown as the inner sleeve 100, to urge the inner sleeve 100 in the direction of the arrow 16 and into forced engagement with the nose 25 to inhibit vibration. In this configuration, the inner sleeve 100 and the outer sleeve 31 may be a forced engagement with the nose 25 and the body 80, such that axial and rotational movement of the inner sleeve 100 (or the sleeve 30) may be limited as a result of this engagement, thereby reducing vibrations that may occur between the sleeve 30 and the body 80.

Reference is now made to FIG. 4, which illustrates an example body assembly 81, according to some example embodiments. The body assembly 81 may comprise the body 80 as well as other components that are affixed to the body 80. As such, the body assembly 81 shown in FIG. 4 may comprise the body 80, the nose 25, and the washer 72. As stated above, the washer 72 may be secured to the body 80 via a groove 84 within an exterior of the body 80. The washer 72, according to some example embodiments, may be snap fit into the groove 84. Alternatively, the washer 72 may be replaced by an integrated ring ledge of the body 80 that extends radially away from the axis 11. Whether implemented as a separate or integrated component, the washer 72 may provide a forward facing surface 73 upon which components of the chuck 10 may be placed and the washer 72 may indirectly provide a surface for leverage to apply the anti-vibration compression force described herein.

The body 80 may include passageways 83 through which the jaws 20 may move to open or close. According to some example embodiments, the body 80 may include three or more passageways 83 that intersect into a central bore of the body 80. As described herein, the jaws 20 may interface with a nut 60 (e.g., via a threaded engagement), and rotation of the nut 60 may cause the jaws 20 to move within the passageways 83. The body 80 may also comprise a spindle interface 85 disposed at a rear end 14 of the body 80. According to some example embodiments, the spindle interface 85 may be threaded for coupling with a spindle of a power driver.

According to some example embodiments, the body 80 may also comprise a plurality of ratchet teeth 82. The ratchet teeth 82 may be angled teeth disposed around an external periphery of a ring portion of the body 80. As further described below, the ratchet teeth 82 may selectively engage with a lock pawl of the lock ring 200 when the lock ring 200 is moved into the locked position to limit movement of the nut 60 that would open the jaws 20. Due to the engagement of the lock pawl with the ratchet teeth 82 while the lock ring 200 is in the locked position, the nut 60 may be permitted to rotate to tighten the jaws 20, but may be prevented from rotating to loosen or open the jaws 20.

The nose 25 may constructed as a cap with a central opening through which that jaws 20 may pass as the jaws 20 extend forward from the central bore of the body 80. The nose 25, according to some example embodiments, may be comprised of a metal and may be affixed to the body 80 in a manner that prevents the nose 25 from moving axially or rotating relative to the body 80. According to some example embodiments, the nose 25 may be press fit or crimped onto to the body 80 in a manner that secures the nose 25 on the body 80 to prevent any movement of the nose 25 relative to the body 80. An external radius of a rear side of the nose 25 may be larger than the external radius of the body 80 at the location where the nose 25 in affixed to the body 80. As such, the nose 25 may form a nose lip 26 around a rear surface of the nose 25 shaped as, for example, a ring. Because the nose 25 may be securely affixed to the body 80, the nose lip 26 may form a fixed surface that a force may be applied to in order to securely couple a component to the body 80 to inhibit vibration. In this regard, a forward end of the sleeve 30 may include a sleeve engaging surface that may engage with the nose lip 26, under the anti-vibration compression force described herein, to limit relative movement between the sleeve 30 and the body 80 and therefore vibration.

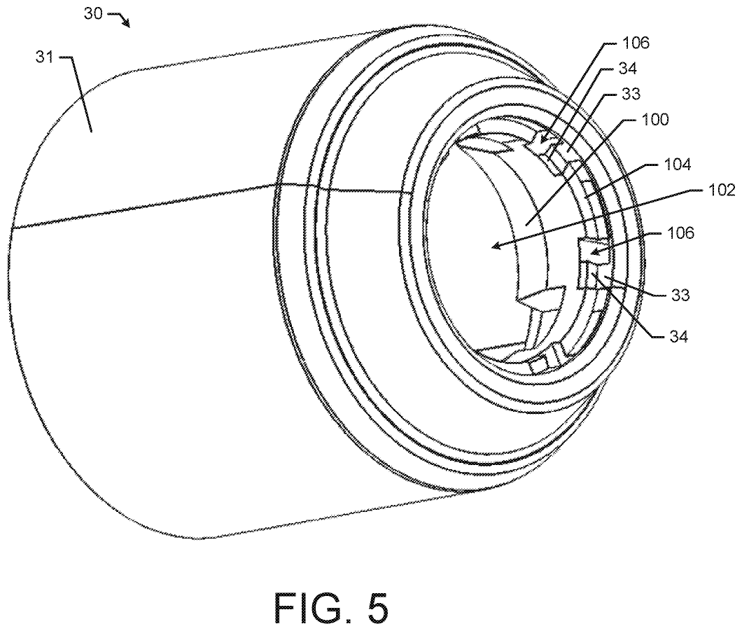

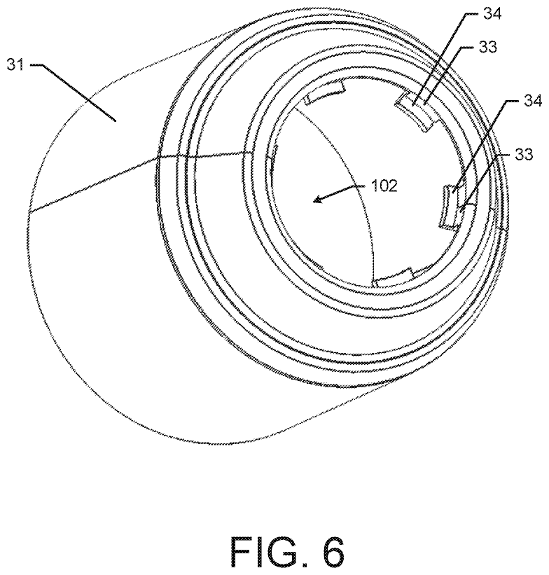

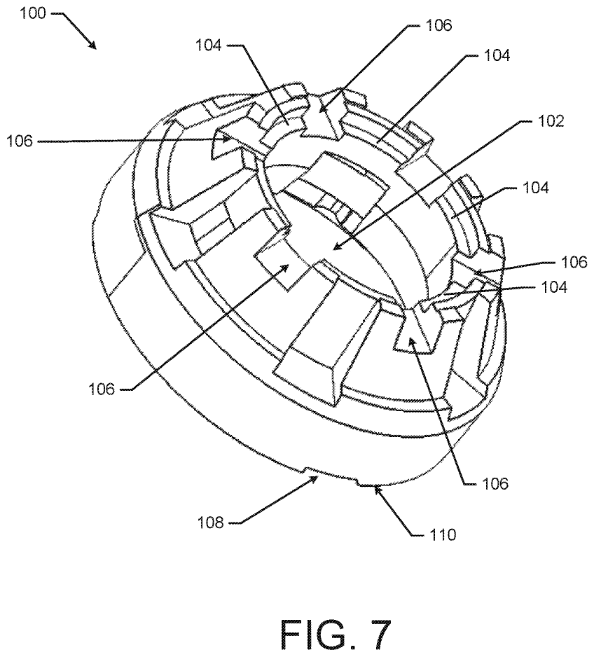

Considering the nose lip 26, reference is now made to FIG. 5, which illustrates an example sleeve 30. As described above, the sleeve 30 may comprise an outer sleeve 31 and the inner sleeve 100. According to some example embodiments, FIG. 5 illustrates the outer sleeve 31 and the inner sleeve 100 in a coupled configuration. As seen in this perspective side view, the inner sleeve 100 and the outer sleeve 31 define an internal opening 102. Around a periphery of the forward end of the outer sleeve 31 and inner sleeve 100, a sleeve engaging surface (or lip) may be included. The inner sleeve 100 comprises an inner sleeve engaging surface 104 and the outer sleeve 31 comprises an outer sleeve engaging surface 34. As better shown in FIG. 7, the inner sleeve engaging surface 104 may defined on a forward end of the inner sleeve 100. However, as shown in FIG. 6, the outer sleeve 31 may comprise internal protrusions 33 that extend into the opening 102, but also extend radially inward to form the outer sleeve engaging surfaces 34. The protrusions 33 may align with recesses 106 in the inner sleeve 100 to permit the inner sleeve engaging surface 104 and the outer sleeve engaging surface 34 to be coplanar for engagement with a planar surface on the backend of the nose 25 that defines the nose lip 26. The sleeve engaging surfaces may extend inward (toward the axis 11) to have an inner radius that is less than an outer radios of the nose lip 26. As such, the sleeve engaging surfaces may align with the nose lip 26 such that the sleeve cannot move forward past the nose lip 26. In other words, the nose lip 26 may operate a physical stop for the sleeve 30.

As shown in FIG. 5, the protrusions 33 of the outer sleeve 31 may be disposed in the recesses 106 of the inner sleeve 100, but according to some example embodiments, the recesses 106 may be wider than the protrusions 33. As such, according to some example embodiments, the outer sleeve 31 may be able to slightly rotate relative to the inner sleeve 100 because of the gap in the recesses 106. This ability to slightly rotate the outer sleeve 31 relative to the inner sleeve 100 may operate to counteract, according to some example embodiments, some inertial forces and permit the outer sleeve 31 to move due to inertia without moving the inner sleeve 100 or possibly the nut 60 to loosen the jaws 20.

Referring to FIG. 7, a forward view of the inner sleeve 100 is shown. As mentioned above, the opening 102 may be disposed in a central portion of the inner sleeve 100. At a forward end of the inner sleeve 100, the recesses 106 may be disposed at locations that align with the protrusions 33 of the outer sleeve 31. Further, the inner sleeve engaging surface 104 may be defined on an inner ledge adjacent to the opening 102. As further, described herein, the inner sleeve engaging surface 104 may be sized for engagement with the nose lip 26 formed by the coupling of the nose 25 with the body 80.

Additionally, the inner sleeve 100 may comprise a damping surface ledge 110 and a damping recess 108, for example, disposed at the rear of the inner sleeve 100. As further described herein, a damping member may be configured to engage with the damping surface ledge 110 on a rear edge of the inner sleeve 100 to apply the anti-vibration compression force on the inner sleeve 100 and urge the inner sleeve 100 forward and into close engagement with the nose lip 26. Additionally, the inner sleeve 100 may comprise a damping recess 108 that is disposed on the rear edge of the inner sleeve 100. Via rotation of the lock ring 200 into an unlocked position, the damping member may be moved into the damping recess 108, which may provide clearance for the damping member to remove the anti-vibration compression force from being applied to the inner sleeve 100 while in the unlocked position.

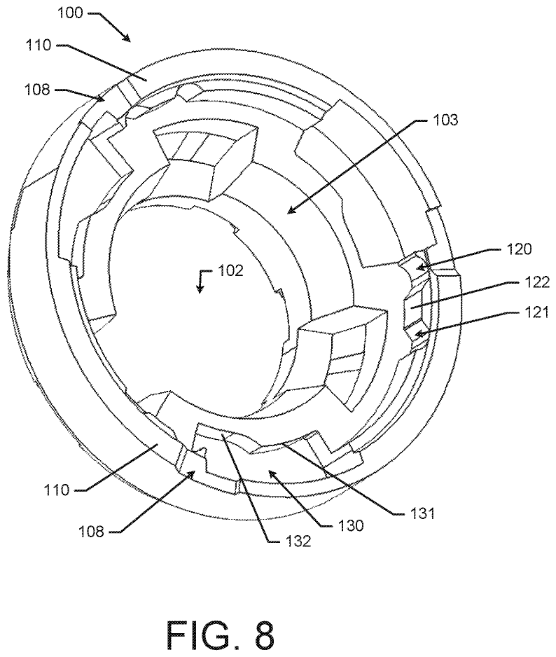

Additionally, on the rear side of the inner sleeve 100 as shown in FIG. 8, various features may be included that facilitate implementing a locked state and an unlocked state of the chuck 10. In this regard, the central portion of the inner sleeve 100 may define the opening 102 and a cavity 103 within which various locking and control features are included that interact with complementary features of the lock ring 200.

In this regard, the inner sleeve 100 may define a plurality of locking features. The inner wall of the cavity 103 may include an unlock recess 120, a lock recess 121, and a raised surface 122 disposed between the unlock recess 120 and the lock recess 121. As further described below, the lock ring 200 may comprise a locking control member 231. The locking control member 231 may be shaped to have a curved surface that can slide across surfaces, but is rounded to facilitate engagement into the unlock recess 120 and the lock recess 121, which may be rounded in a complementary manner. As such, when the locking control member 231 is engaged with the unlock recess 120, the lock ring 200 may be in the unlocked position and the chuck 10 may be in an unlocked state. However, when the locking control member 231 is engaged with the lock recess 121, the lock ring 200 may be in the locked position and the chuck 10 may be in an unlocked state. Additionally, to transition between the locked position and the unlocked position, the locking control member 231, which may be mechanically biased toward the unlock recess 120 or the lock recess 121, may slide over the raised surface 122. As such, the relative height of the raised surface 122 may be defined based on a desired force (e.g., threshold force) needed to move the locking control member 231 over the raised surface 122 and between the locked and unlocked positions.

The inner sleeve 100 may also include a lock pawl cavity 130, which may include features for controlling a position of a lock pawl 222 to either be engaged with the ratchet teeth 82 of the body 80 (i.e., associated with the locked position) or be disengaged from the ratchet teeth 82 (i.e., associated with the unlocked position). More specifically, the lock pawl cavity 130 may include a two-level surface that a lock pawl control member 221 may slide across when transitioning between the unlocked position and the locked position. According to some example embodiments, the two-level surface may be disposed on an inner wall (i.e., closer to a central axis) of the lock pawl cavity 130. According to some example embodiments, the two-level surface of the lock pawl cavity 130 may comprise a lock pawl unlock surface 131 and a lock pawl lock surface 132. According to some example embodiments, a ramp may be disposed between lock pawl unlock surface 131 and the lock pawl lock surface 132 to facilitate smooth transitions between the locked position and the unlocked position. According to some example embodiments, the lock pawl lock surface 132 may be disposed closer to the center axis and the ratchet teeth 82 of the body 80 than the lock pawl unlock surface 131.

Additionally, damping features of the inner sleeve 100 are also shown in FIG. 8. In this regard, the damping surface ledge 110 and the damping recess 108 can be seen. According to some example embodiments, the damping surface ledge 110 and the damping recess 108 may be disposed on a back or rear facing edge of the inner sleeve 100 or another rear-facing surface. In this regard, according to some example embodiments, the rear-facing edge of the inner sleeve 100 may be embodied as a circular ring. The damping surface ledge 110 may extend further rearward (or towards the back end 14) than the damping recess 108. As further described below, a damping member may move between the damping surface ledge 110 and the damping recess 108 as the lock ring 200 moves between a locked position and an unlocked position, respectively. According to some example embodiments, a ramp or angled transition may be disposed between the damping surface ledge 110 and the damping recess 108 to facilitate sliding transitions of the damping member between engagement with the damping surface ledge 110 and the damping recess 108. According to some example embodiments, the damping surface ledge 110 may comprise a planar surface such that a plane of the surface is perpendicular to the axis 11 and therefore a force applied to the damping surface ledge 110 (i.e., the anti-vibration compression force) may be normal to the surface and parallel to the axis 11.

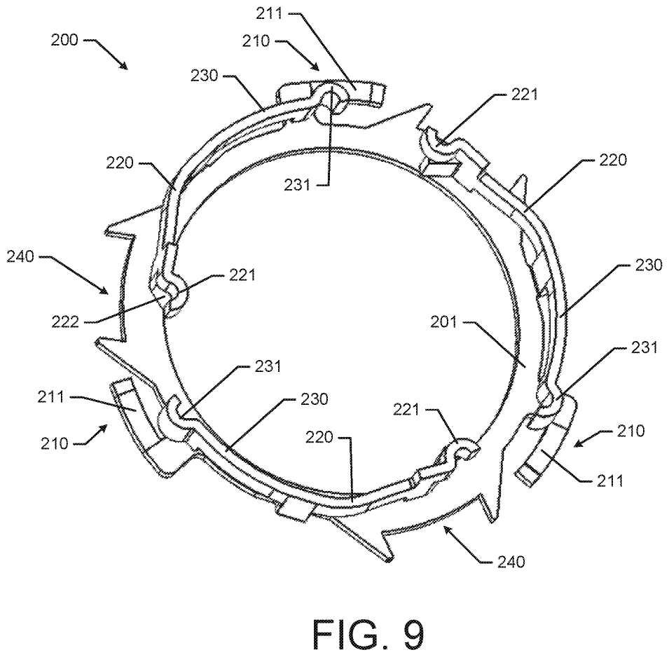

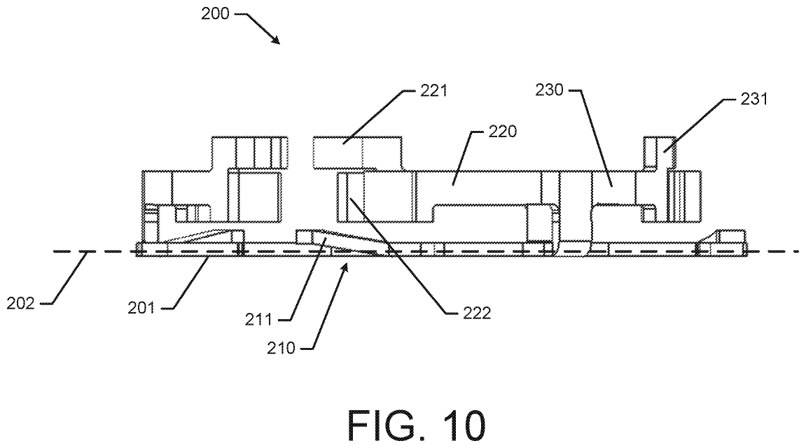

Now referring to FIGS. 9 and 10, a perspective front view of the lock ring 200 and a side view of the lock ring 200 are shown, respectively. The lock ring 200 may include a ring portion 201 that forms a base structure from which various elements may extend. In this regard, lug recesses 240 on the sides of the ring portion 201 may be formed in the ring portion 201 or via the extending protrusions from the ring portion 201, as shown in FIG. 9. As further described below, the lug recesses 240 may be shaped to receive respective lugs 52 of the nut retainer 50 to rotationally couple the nut 60 and the nut retainer 50 to the lock ring 200.

The lock ring 200 may also include various features that operate in cooperation with features of the inner sleeve 100 to support locking and unlocking functionalities. In this regard, the lock ring 200 may include mechanically biased elements that are configured to engage with, and in some instances temporarily latch with, corresponding features of the inner sleeve 100. Such mechanical (or spring) bias may be introduced via bending of, for example, metal components similar to a leaf spring. In this regard, the lock ring 200 may comprise one or more risers from which mechanically biased arms may extend, for example, on a forward side of the ring portion 201.

In this regard, according to some example embodiments, a mechanically biased lock pawl arm 220 may extend from, for example, a riser. A lock pawl 222 and lock pawl control member 221 may be disposed on the lock pawl arm 220. The lock pawl arm 220 may be biased inwards, toward a center of the lock ring 200 (and toward the axis 11). As such, the lock pawl 222 and the lock pawl control member 221 may also be biased inwards. As further described below, the lock pawl control member 221 may be disposed forward of the lock pawl 222 such that the lock pawl control member 221 may be disposed with in the lock pawl cavity 130 of the inner sleeve 100 while the lock pawl 222 may remain outside of the lock pawl cavity 130. The lock pawl control member 221 may have a rounded surface on an inside face to facilitate sliding engagement with the lock pawl unlock surface 131 and the lock pawl lock surface 132 of the lock pawl cavity 130 of the inner sleeve 100. The lock pawl 222 may be disposed rearward of the lock pawl control member 221 on the lock pawl arm 220 and therefore need not be disposed in the lock pawl cavity 130 of the inner sleeve 100. As such, the lock pawl 222, which may comprise an inward angled tooth, may be selectively engagable with the ratchet teeth 82 of the body 80. In this regard, the engagement of the lock pawl control member 221 with either the lock pawl unlock surface 131 or the lock pawl lock surface 132 may control whether the lock pawl 222 is disengaged from the ratchet teeth 82 or engaged with the ratchet teeth 82.

Additionally, the lock ring 200 may also include a locking control arm 230 that extends from the riser or otherwise from the lock ring 200. The locking control arm 230 may also be mechanically biased, and the locking control arm 230 may include a locking control member 231 disposed at an end of the locking control arm 230. According to some example embodiments, the locking control member 231 may have a rounded surface that, for example, faces outward (away from a center of the lock ring 200 or the axis 11) and in the direction of the mechanical bias of the locking control arm 230. The rounded surface may facilitate sliding of the locking control member 231 into and out of engagement with the unlock recess 120 and lock recess 121 of the inner sleeve 100. Such rounded surface may also facilitate sliding over the raised surface 122. According to some example embodiments, the unlock recess 120 and the lock recess 121 may be shaped to correspond with the shape of the locking control member 231. Such matched shapes may facilitate a latching of the locking control member 231 into engagement with the unlock recess 120 and the lock recess 121 and may, as a result, require a force exceeding a threshold to move the locking control member 231 out of engagement with the unlock recess 120 or the lock recess 121, thereby countering inertia that might cause, for example unintended loosening when the lock ring 200 is in the locked position. In this regard, when the locking control member 231 is disposed in the lock recess 121, the lock ring 200 may be in the locked position and when the locking control member 231 is in the unlock recess 120, the lock ring 200 may be in the unlocked position.

According to some example embodiments, the lock ring 200 may also include one or more damping members 210. A damping member 210 may be a component of the lock ring 200 that operates to apply an anti-vibration compression force on the inner sleeve 100 (or the sleeve 30) to urge the inner sleeve 100 (or the sleeve 30) into a forced engagement with the body 80 or an assembly comprising the body 80. In this regard, according to some example embodiments, the damping member 210 may be an extension or protrusion from the lock ring 200 that selectively engages with the inner sleeve 100 to apply the anti-vibration compression force when the lock ring 200 is in the locked position and not apply the anti-vibration compression force when the lock ring 200 is in the unlocked position. As such, the damping member 210 may comprise an angled surface, angled threading, or the like that may cause the anti-vibration compression force to be applied when the lock ring 200 is rotated into the locked position. According to some example embodiments, the damping member 210 may be embodied as a leaf spring.

According to some example embodiments, the damping member 210 may comprise or be embodied by a damping arm 211. The damping arm 211 may be formed of a metal material and may exhibit a mechanical bias (or spring bias). The damping arm 211 may extend from, for example, the ring portion 201 of the lock ring 200. Initially, the damping arm 211 may extend from the ring portion 201 at a plane 202 of the ring portion 201 that is perpendicular to the axis 11. However, according to some example embodiments, the damping arm 211 may be angled to extend out of the plane 202 of the ring portion 201. In this regard, for example, an end of the damping arm 211 may be disposed out of the plane 202 of the ring portion 201 and the end of the damping arm 211 may be biased in a forward direction (i.e., toward the forward end 13 of the chuck 10). As such, the damping arm 211 may be configured to apply an anti-vibration compression force on the inner sleeve 100 of the chuck 10 as a result of the forward directed bias. When the lock ring 200 is in the locked position, the damping arm 211 may be in engagement with the damping surface ledge 110 of the inner sleeve 100 and the damping arm 211 may be under compression by the damping surface ledge 110, which may thereby cause a responsive force to the applied to the inner sleeve 100. In turn, this anti-vibration compression force on the inner sleeve 100 may cause the inner sleeve engaging surface 104 and the outer sleeve engaging surface 34 to be forced against the nose lip 26 to increase the coupling between the sleeve 30 and the body 80 and inhibit vibration.

As such, due to the engagement between the damping arm 211 and the damping surface ledge 110, the anti-vibration compression force may be applied when the lock ring 200 is in the locked position. However, when the lock ring 200 is rotated into the unlocked position, the damping arm 211 may move into the damping recess 108, which may permit the damping arm 211 to partially or fully deflect, thereby reducing or eliminating application of the anti-vibration compression force. As such, the sleeve 30 may not be in a forced engagement with the nose lip 26 when the chuck 10 is in the unlocked state and therefore the sleeve 30 may rotate relative to the nose lip 26 without having to overcome a high friction that would be present when the anti-vibration compression force is applied.

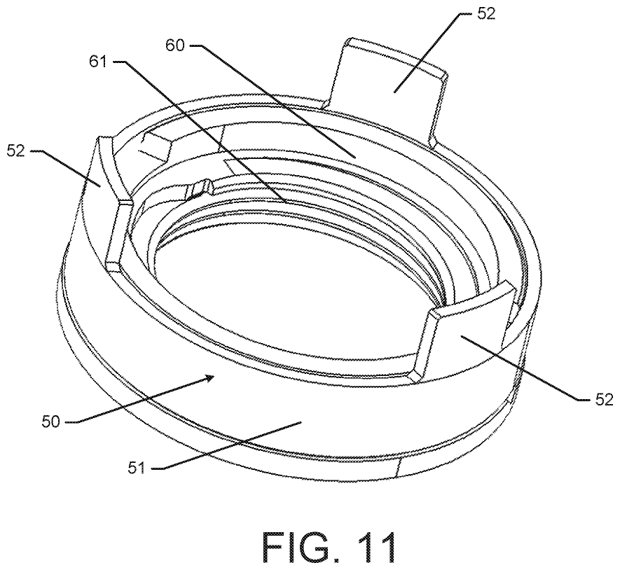

Referring now to FIG. 11, a perspective view of the nut 60 and the nut retainer 50 is provided. The nut retainer 50 may be affixed to the nut 60 such that the nut retainer 50 rotates with the nut 60. As such, the nut retainer 50 may be press fit, crimped, bonded, or the like to nut 60. According to some example embodiments, the nut retainer 50 may be integrated with the nut 60 such that the nut 60 and the nut retainer 50 are a single component.

As mentioned above, the nut 60 may comprise threading 61 that may be configured to engage with threads 21 of the jaws 20. Due to the threaded engagement between the nut 60 and the jaws 20, rotation of the nut 60 may cause the jaws 20 to move within passageways 83 of the body 80 to either open or close. Additionally, the nut retainer 50 may comprise lugs 52. The lugs 52 may be protruding elements that extend in a forward direction from a forward end of the nut 60 and engage with the lock ring 200 such that the nut 60, nut retainer 50, and lock ring 200 rotate together. In this regard, the lugs 52 may be sized to fit within the lug recesses 240 of the lock ring 200 such that movement of the lugs 52 causes movement of the lock ring 200.

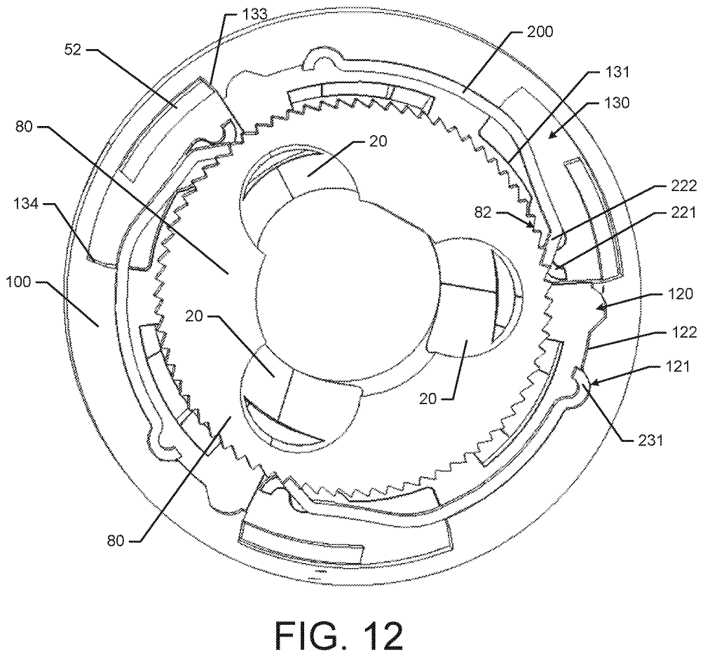

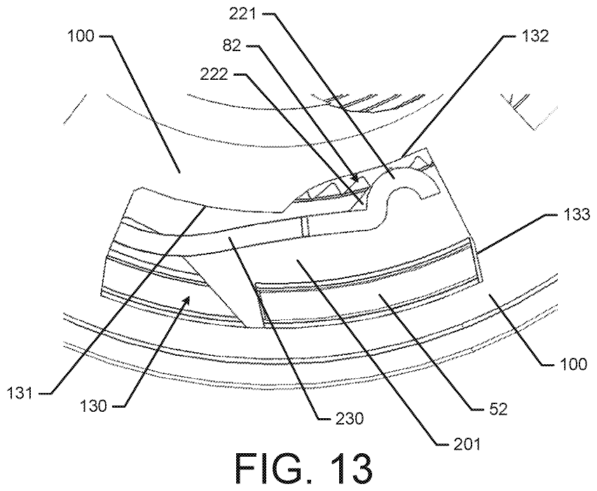

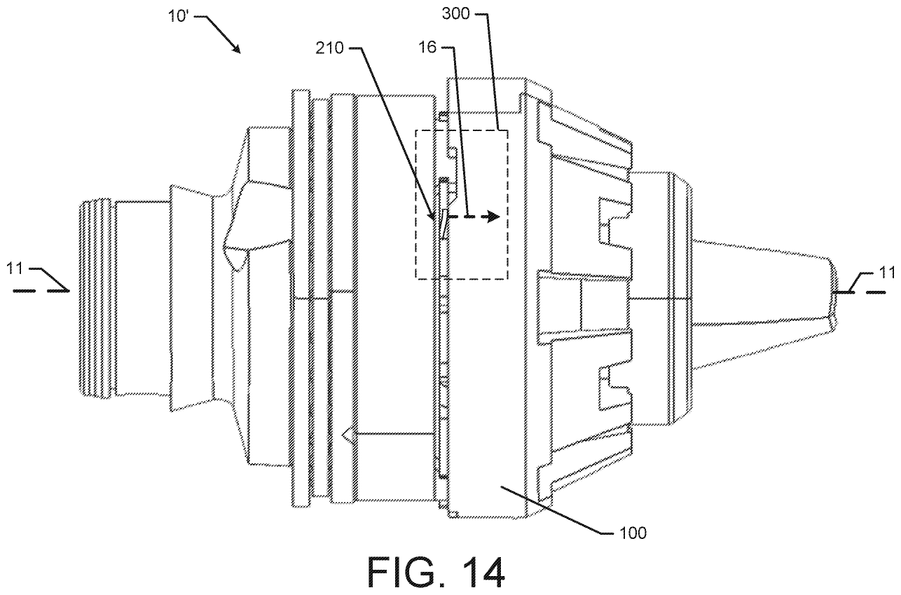

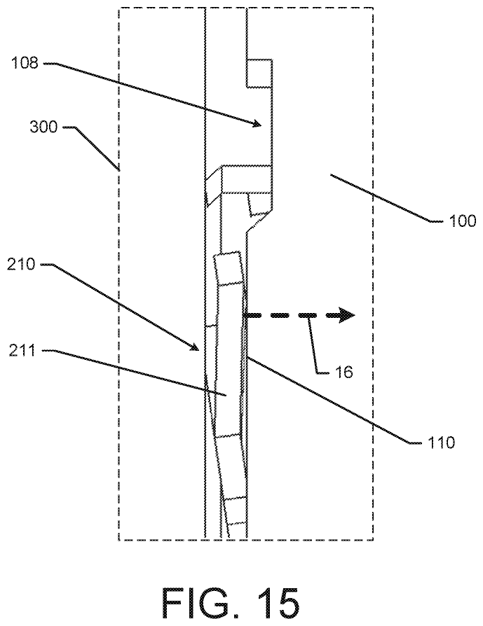

Having described various components of the chuck 10 and some aspects of the functionalities of various components, a description of FIGS. 12-18 is now provided to show and describe collaborative interactions of components, according to some example embodiments. In this regard, FIGS. 12-15 will now be described, 1 which illustrate the chuck 10′ and various components in locked positions to permit operation in the locked state and application of the anti-vibration compression force. In this regard, FIG. 12 shows a cross-section view of the chuck 10′ of FIG. 3 taken at A-A viewed from the rear, when the chuck 10′ is in a locked state with the lock ring 200 in a locked position. FIG. 13 is a partial cross-section zoomed view of the chuck 10′ in the locked state, with the cross-section taken at B-B when viewed from the front. FIG. 14 is a side view of the chuck 10′ with the damping member 210 applying an anti-vibration compression force due to the chuck 10′ being in the locked state. Further, FIG. 15 is zoomed side view taken in the region 300 of the damping member 210 applying an anti-vibration compression force due to the chuck 10′ being in the locked state.

As can be seen in FIGS. 12 and 13, because the lock ring 200 has been rotated into the locked position, the locking control member 231 is disposed in the lock recess 121. Further, the lug 52 of the nut retainer 50 is disposed against a tightening sidewall 133 of the lock pawl cavity 130. As such, rotation of the inner sleeve 100 causes the sidewall 133 to engage with and rotate the lug 52 and the nut 60 in a jaw closing direction as the inner sleeve 100 is turned (i.e., in a counter-clockwise direction in FIG. 12 and a clockwise direction in FIG. 13, due to the difference in viewpoint). Because the lock pawl lock surface 132 is positioned inward and the lock pawl control member 221, disposed within the lock pawl cavity 130 of the inner sleeve 100, is not be engaged with any surface, the lock pawl 222 is permitted to deflect into engagement with the ratchet teeth 82 due to the mechanical bias of the lock pawl arm 220. Due to the angled engagement between the lock pawl 222 and the ratchet teeth 82, the rotation of the lock ring 200 may be prevented if the inner sleeve 100 is rotated in an opening direction (i.e., counter-clockwise in FIG. 13).

Now referencing FIGS. 14 and 15, the damping member 210 embodied as the damping arm 211 of the lock ring 200 is positioned in engagement with the damping surface ledge 110 of the inner sleeve 100. As such, the mechanical bias of the damping arm 211 may cause an anti-vibration compression force to be applied in the direction of the arrow 16, which is parallel to the axis 11 of the chuck 10′. Accordingly, the inner sleeve 100 may be forced into close engagement with the nose 25 and more specifically, the nose lip 26 as described above.

Referring back to FIG. 12, when the chuck 10′ transitions to the unlocked state, the inner sleeve 100 rotates in a clockwise direction. However, due to the engagement of the lock pawl 222 with the ratchet teeth 82, the lock ring 200 remains stationary until the loosening sidewall 134 of the lock pawl cavity 130 comes into contact with the lug 52. However, during rotation of the inner sleeve 100 relative to the lock ring 200 due to application of at least a threshold rotating force applied by the user on the sleeve 30, the locking control member 231 moves out of the lock recess 121, over the raised surface 122 and into the unlock recess 120. Additionally, during this movement of the inner sleeve 100 relative to the lock ring 200, the inner sleeve 100 moves relative to the damping arm 211 to move the damping arm 211 out of engagement with the damping surface ledge 110 and into the damping recess 108. As a result, the damping arm 211 is permitted to fully deflect into the damping recess 108 without contacting the inner sleeve 100, and therefore the anti-vibration compression force is no longer applied to the inner sleeve 100. Further, once the locking control member 231 is located in the unlock recess 120 and the lug 52 is engaged with the loosening sidewall 134, continued rotation of the inner sleeve 100 forces the lug 52, and thus the nut 60, to rotate thereby causing the jaws 20 to open without being impeded by a forced engagement of the sleeve 30 on the nose lip 26 caused by the anti-vibration compression force.

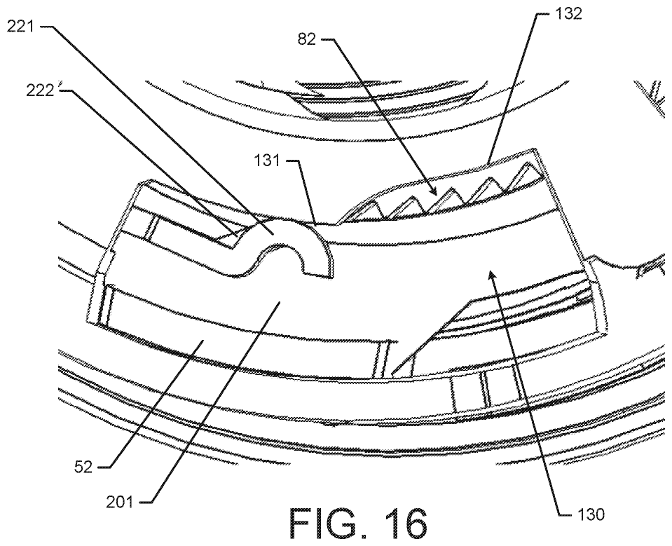

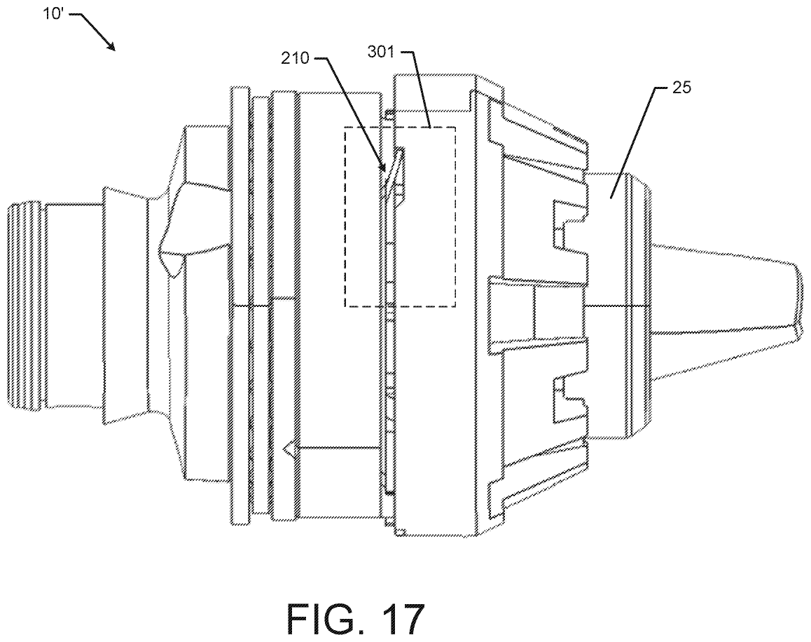

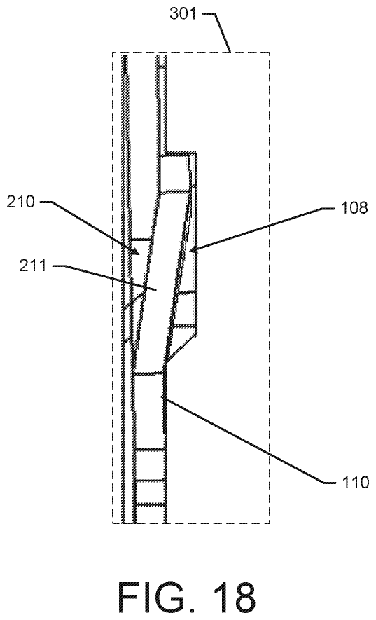

Accordingly, FIGS. 16-18 illustrate the chuck 10′ in the unlocked state, where the lock ring 200 is disposed in the unlocked position (i.e., the locking control member 231 is disposed in the unlock recess 120). FIG. 16 is a partial cross-section zoomed view of the chuck 10′ in the unlocked state, with the cross-section taken at C-C of the chuck 10′ of FIG. 17 when viewed from the front. FIG. 17 is a side view of the chuck 10′ with the damping member 210 moved into the damping recess 108 and therefore no anti-vibration compression force is applied due to the chuck 10′ being in the unlocked state. Further, FIG. 18 is zoomed side view taken in the region 301 of the damping member 210 moved into the damping recess 108 and therefore no anti-vibration compression force is applied due to the chuck 10′ being in the unlocked state.

With reference to FIG. 16, it can be seen that the lock pawl control member 221 has ridden on the ramp from the lock pawl lock surface 132 and into engagement with the lock pawl unlock surface 131. The engagement between the lock pawl control member 221 and the lock pawl unlock surface 131 urges the lock pawl control member 221 and the lock pawl 222 outward (away from the axis 11) against the mechanical bias of the lock pawl arm 220, such that the lock pawl 222 is not engaged with the ratchet teeth 82. As such, the sleeve 30 is free to rotate in an opening or closing direction without being inhibited by the lock pawl 222's engagement with the ratchet teeth 82. However, if rotation of the sleeve 30 causes the jaws 20 to begin to clamp onto a bit, a threshold rotational force may be required to continue to close the jaws 20. As such, the inner sleeve 100 may rotate relative to the lock ring 200 as application of the threshold force urges the locking control member 231 out of the unlock recess 120 and into the lock recess 121, thereby placing the chuck 10 back into the locked state as described above.

Referring to FIGS. 17 and 18, the damping member 210, embodied as the damping arm 211 of the lock ring 200, is positioned in the damping recess 108, and has moved out of engagement with the damping surface ledge 110 of the inner sleeve 100 due to being in the unlocked state. As such, the mechanical bias of the damping arm 211 may cause the damping arm 211 to deflect into the damping recess 108, but since no physical engagement (or some lesser application of force) between the damping arm 211 and the inner sleeve 100 occurs, the anti-vibration compression force is not applied on the inner sleeve 100. Accordingly, the sleeve 30 (including the inner sleeve 100) may be free to rotate without being encumbered by the forced engagement between the sleeve 30 and the nose lip 26 that is present in the locked state when the anti-vibration compression force is applied.

According to some example embodiments, a first embodiment of a chuck for use with a power driver having a rotatable drive spindle is provided. The chuck may comprise a plurality of jaws, and a body assembly configured to rotate with the drive spindle. The plurality of jaws may be configured to rotate with the body assembly about a center axis of the chuck, and the plurality of jaws may also move relative to the body assembly in an opening or closing direction. The chuck may also comprise a nut operably coupled to the jaws such that rotation of the nut relative to the body assembly moves the jaws relative to the body assembly in the opening or closing direction. The chuck may also comprise a sleeve coupled to the nut and the body assembly, and a lock ring operably coupled to the nut and the sleeve and configured to rotate with the nut. The lock ring may comprise a lock ring interface with a damping member. The lock ring interface being configured to, when the lock ring is in an unlocked position relative to the sleeve, permit rotation of the nut relative to the body assembly in a first rotational direction to move the jaws in the closing direction and also permit rotation of the nut relative to the body assembly in a second rotational direction to move the jaws in the opening direction. In this regard, the second rotational direction may be opposite the first rotational direction. Additionally, the lock ring interface being configured to, when the lock ring is in the locked position, permit rotation of the nut relative to the body assembly in the first rotational direction to move the jaws in the closing direction, prevent rotation of the nut relative to the body assembly in the second rotational direction, and apply an anti-vibration compression force by the damping member on the sleeve to increase an engagement force between sleeve and the body assembly to reduce vibration in the chuck when the lock ring is in the locked position.

The first embodiment of a chuck described above may be modified, augmented, or may include optional additions, some of which are described herein. The modifications, augmentations, or optional additions listed below are some examples of elements that may be added in any desirable combination. Within this context, other embodiments may be defined by combinations of modifications, augmentations or optional additions. For example, in a second embodiment the damping member may comprise a damping arm that extends from a ring portion of the lock ring. The damping arm may have a damping mechanical bias to urge the sleeve into engagement with a nose lip of the body assembly when the lock ring is in the locked position. The nose lip may be disposed in a fixed axial position on the body assembly such that application of the anti-vibration compression force on the sleeve increases a frictional engagement between the sleeve and the body assembly. Additionally, in a third embodiment, the damping arm may be a leaf spring that is angled out of a plane of the ring portion. The third embodiment may be combined with any or all of embodiments one or two, as appropriate. Alternatively, in a fourth embodiment, the damping mechanical bias of the damping arm may be directed in a forward direction towards a front of the chuck to urge the sleeve towards the nose lip to increase a frictional engagement between the sleeve and the nose lip when the lock ring is in the locked position. The fourth embodiment may be combined with any or all of embodiments one to three, as appropriate. In a fifth embodiment, the sleeve may comprise a damping surface ledge and a damping recess. When the lock ring is in the locked position, the damping member may be engaged with the damping surface ledge and apply the anti-vibration compression force onto the sleeve. When the lock ring is in the unlocked position, the damping member may be located within the damping recess such that the damping member does not apply the anti-vibration compression force onto the sleeve. The fifth embodiment may be combined with any or all of embodiments one to four, as appropriate. In a sixth embodiment, the damping surface ledge and the damping recess may be disposed on an interior rear-facing rim of the sleeve. The sixth embodiment may be combined with any or all of embodiments one to five, as appropriate. In a seventh embodiment, the lock ring may comprise a lock pawl and a lock pawl control member. When the lock ring is in the locked position, the lock pawl control member may be disposed in a lock recess to permit a lock pawl control member mechanical bias on the lock pawl to urge the lock pawl into engagement with a ratchet tooth of a plurality of ratchet teeth that rotate with the body assembly to prevent rotation of the lock ring and the nut relative to the body assembly in the second rotational direction but permit ratcheting and rotation of the lock ring and the nut in a first rotational direction. When the lock ring is in the unlocked position, the lock pawl control member may be engaged with the unlock ledge against a force of the lock pawl control member mechanical bias to move the lock pawl out of engagement with the plurality of ratchet teeth and permit rotation of the lock ring and the nut in the first rotational direction and second rotational direction. The seventh embodiment may be combined with any or all of embodiments one to six, as appropriate. In an eighth embodiment, the sleeve may comprise the lock recess and the unlock ledge. The eighth embodiment may be combined with any or all of embodiments one to seven, as appropriate. In the ninth embodiment, the lock ring may comprise a locking control member. When the lock ring is in the locked position, the locking control member may be engaged with a complementary lock feature that requires application of a threshold rotational unlock force to disengage the locking control member from the complementary lock feature. The ninth embodiment may be combined with any or all of embodiments one to eight, as appropriate. In a tenth embodiment, when the lock ring is in the locked position, the locking control member may be engaged with a complementary lock feature that requires application of a threshold rotational unlock force to disengage the locking control member from the complementary lock feature to move the lock ring to the unlocked position. The tenth embodiment may be combined with any or all of embodiments one to nine, as appropriate. In an eleventh embodiment, when the lock ring is in the unlocked position, the locking control member may be engaged with a complementary unlock feature that requires application of a threshold rotational lock force to disengage the locking control member from the complementary unlock feature to move the lock ring to the locked position. The eleventh embodiment may be combined with any or all of embodiments one to ten, as appropriate. In a twelfth embodiment, the sleeve may comprise the complementary lock feature and the complementary unlock feature. The twelfth embodiment may be combined with any or all of embodiments one to eleven, as appropriate. In a thirteenth embodiment, the lock ring and the nut may move relative to the sleeve when transitioning between the locked position and the unlocked position. The thirteenth embodiment may be combined with any or all of embodiments one to twelve, as appropriate.

According to some example embodiments, a fourteenth embodiment of a chuck is provided. The chuck may comprise a body assembly, and a plurality of jaws. The plurality of jaws may rotate with the body assembly about a center axis of the chuck and may also move relative to the body assembly in an opening or closing direction. The chuck may also comprise a nut operably coupled to the jaws such that rotation of the nut relative to the body assembly moves the jaws relative to the body assembly in the opening or closing direction. The chuck may also comprise a sleeve and a lock ring operably coupled to the nut and the sleeve. The lock ring may be coupled to the nut such that the lock ring and the nut rotate together. The lock ring may be coupled to the sleeve such that the lock ring rotates relative to the sleeve when transitioning between a locked position and an unlocked position. The lock ring may comprise a damping member configured to apply an anti-vibration compression force on the sleeve to increase an engagement force between sleeve and the body assembly to reduce vibration in the chuck when the lock ring is in the locked position. The anti-vibration compression force is not applied when the lock ring is in the unlocked position. When the lock ring is in a locked position, rotation of the nut relative to the body assembly to move the jaws in the opening direction is prevented.

The fourteenth embodiment of a chuck described above may be modified, augmented, or may include optional additions, some of which are described herein. The modifications, augmentations, or optional additions listed below are some examples of elements that may be added in any desirable combination. Within this context, other embodiments may be defined by combinations of modifications, augmentations or optional additions. For example, in a fifteenth embodiment, the damping member may comprise a damping arm that extends from a ring portion of the lock ring and out of a plane of a ring portion of the lock ring. The damping arm may have a mechanical bias to urge the sleeve toward the body assembly when the lock ring is in the locked position. The fifteenth embodiment may be combined with embodiment fourteen. In a sixteenth embodiment, the damping member may exhibit a damping mechanical bias directed in a forward direction towards a front of the chuck to urge the sleeve towards a nose lip of the body assembly. The sixteenth embodiment may be combined with any or all of embodiments fourteen to fifteen, as appropriate. In a seventeenth embodiment, the sleeve may comprise a damping surface ledge and a damping recess. When the lock ring is in the locked position, the damping member may be engaged with the damping surface ledge and applies the anti-vibration compression force onto the sleeve. When the lock ring is in the unlocked position, the damping member may be located within the damping recess such that the damping member does not apply the anti-vibration compression force onto the sleeve. The seventeenth embodiment may be combined with any or all of embodiments fourteen to sixteen, as appropriate. In an eighteenth embodiment, the damping surface ledge and the damping recess may be disposed on the sleeve. The eighteenth embodiment may be combined with any or all of embodiments fourteen to seventeen, as appropriate.

According to some example embodiments, another chuck is provided as a nineteenth embodiment. The chuck may comprise a body assembly and a plurality of jaws. The plurality of jaws may rotate with the body assembly about a center axis of the chuck. The plurality of jaws may also move relative to the body assembly in an opening or closing direction. The chuck may also comprise a nut operably coupled to the jaws such that rotation of the nut relative to the body assembly moves the jaws relative to the body assembly in the opening or closing direction. The chuck may further comprise a sleeve, and a lock ring operably coupled to the nut and the sleeve. The lock ring may be coupled to the nut such that the lock ring and the nut rotate together. The lock ring may be coupled to the sleeve such that the lock ring rotates relative to the sleeve when transitioning between a locked position and an unlocked position. The lock ring may comprise a ring portion and a damping arm. The ring portion may define a ring portion plane, and the damping arm may from the ring portion at an angle such that an end of the damping arm is out of the ring portion plane. The damping arm may exhibit a damping mechanical bias and the damping arm may be configured to apply an anti-vibration compression force that is directed parallel to the center axis of the chuck, via the damping mechanical bias, on the sleeve to increase an engagement force between internal sleeve and the external sleeve to reduce vibration in the chuck when the lock ring is in the locked position. The anti-vibration compression force is not applied when the lock ring is in the unlocked position. When the lock ring is in a locked position, rotation of the nut relative to the body assembly to move the jaws in the opening direction is prevented.

The nineteenth embodiment of a chuck described above may be modified, augmented, or may include optional additions, some of which are described herein. The modifications, augmentations, or optional additions listed below are some examples of elements that may be added in any desirable combination. Within this context, other embodiments may be defined by combinations of modifications, augmentations or optional additions. For example, in a twentieth embodiment, the sleeve may comprise a damping surface ledge and a damping recess. When the lock ring is in the locked position, the damping arm may be engaged with the damping surface ledge and applies the anti-vibration compression force onto the sleeve. When the lock ring is in the unlocked position, the damping arm may be located within the damping recess such that the damping arm does not apply the anti-vibration compression force onto the sleeve.

Many modifications and other embodiments of the chucks set forth herein will come to mind to one skilled in the art to which these embodiments pertain having the benefit of the teachings presented in the foregoing descriptions and the associated drawings. Therefore, it is to be understood that the chucks are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A chuck for use with a power driver having a rotatable drive spindle, the chuck comprising:
a plurality of jaws;
a body assembly configured to rotate with the drive spindle, wherein the plurality of jaws are configured to rotate with the body assembly about a center axis of the chuck, wherein the plurality of jaws also move relative to the body assembly in an opening or closing direction;
a nut operably coupled to the jaws such that rotation of the nut relative to the body assembly moves the jaws relative to the body assembly in the opening or closing direction;
a sleeve coupled to the nut and the body assembly; and
a lock ring operably coupled to the nut and the sleeve and configured to rotate with the nut, the lock ring comprising a lock ring interface with a damping member, the lock ring interface being configured to:
when the lock ring is in an unlocked position relative to the sleeve, permit rotation of the nut relative to the body assembly in a first rotational direction to move the jaws in the closing direction and also permit rotation of the nut relative to the body assembly in a second rotational direction to move the jaws in the opening direction, the second rotational direction being opposite the first rotational direction; and
when the lock ring is in the locked position, permit rotation of the nut relative to the body assembly in the first rotational direction to move the jaws in the closing direction, prevent rotation of the nut relative to the body assembly in the second rotational direction, and apply an anti-vibration compression force by the damping member on the sleeve to increase an engagement force between sleeve and the body assembly to reduce vibration in the chuck when the lock ring is in the locked position.

2. The chuck of claim 1, wherein the damping member comprises a damping arm that extends from a ring portion of the lock ring, the damping arm having a damping mechanical bias to urge the sleeve into engagement with a nose lip of the body assembly when the lock ring is in the locked position;
wherein the nose lip is disposed in a fixed axial position on the body assembly such that application of the anti-vibration compression force on the sleeve increases a frictional engagement between the sleeve and the body assembly.

3. The chuck of claim 2, wherein the damping arm is a leaf spring that is angled out of a plane of the ring portion.

4. The chuck of claim 2, wherein the damping mechanical bias of the damping arm is directed in a forward direction towards a front of the chuck to urge the sleeve towards the nose lip to increase a frictional engagement between the sleeve and the nose lip when the lock ring is in the locked position.

5. The chuck of claim 1, wherein the sleeve comprises a damping surface ledge and a damping recess;
wherein, when the lock ring is in the locked position, the damping member is engaged with the damping surface ledge and applies the anti-vibration compression force onto the sleeve;
wherein, when the lock ring is in the unlocked position, the damping member is located within the damping recess such that the damping member does not apply the anti-vibration compression force onto the sleeve.

6. The chuck of claim 5, wherein the damping surface ledge and the damping recess are disposed on an interior rear-facing rim of the sleeve.

7. The chuck of claim 1, wherein the lock ring comprises a lock pawl and a lock pawl control member;
wherein, when the lock ring is in the locked position, the lock pawl control member is disposed in a lock recess to permit a lock pawl control member mechanical bias on the lock pawl to urge the lock pawl into engagement with a ratchet tooth of a plurality of ratchet teeth that rotate with the body assembly to prevent rotation of the lock ring and the nut relative to the body assembly in the second rotational direction but permit ratcheting and rotation of the lock ring and the nut in a first rotational direction; and
wherein, when the lock ring is in the unlocked position, the lock pawl control member is engaged with the unlock ledge against a force of the lock pawl control member mechanical bias to move the lock pawl out of engagement with the plurality of ratchet teeth and permit rotation of the lock ring and the nut in the first rotational direction and second rotational direction.

8. The chuck of claim 7, wherein the sleeve comprises the lock recess and the unlock ledge.

9. The chuck of claim 7, wherein the lock ring comprises a locking control member;
wherein, when the lock ring is in the locked position, the locking control member is engaged with a complementary lock feature that requires application of a threshold rotational unlock force to disengage the locking control member from the complementary lock feature.

10. The chuck of claim 9, wherein, when the lock ring is in the locked position, the locking control member is engaged with a complementary lock feature that requires application of a threshold rotational unlock force to disengage the locking control member from the complementary lock feature to move the lock ring to the unlocked position.

11. The chuck of claim 10, wherein, when the lock ring is in the unlocked position, the locking control member is engaged with a complementary unlock feature that requires application of a threshold rotational lock force to disengage the locking control member from the complementary unlock feature to move the lock ring to the locked position.

12. The chuck of claim 11, wherein the sleeve comprises the complementary lock feature and the complementary unlock feature.

13. The chuck of claim 1, wherein the lock ring and the nut move relative to the sleeve when transitioning between the locked position and the unlocked position.

14. A chuck comprising:
a body assembly;
a plurality of jaws, wherein the plurality of jaws rotate with the body assembly about a center axis of the chuck, wherein the plurality of jaws also move relative to the body assembly in an opening or closing direction;
a nut operably coupled to the jaws such that rotation of the nut relative to the body assembly moves the jaws relative to the body assembly in the opening or closing direction;
a sleeve; and
a lock ring operably coupled to the nut and the sleeve, the lock ring being coupled to the nut such that the lock ring and the nut rotate together, the lock ring being coupled to the sleeve such that the lock ring rotates relative to the sleeve when transitioning between a locked position and an unlocked position;
wherein the lock ring comprises a damping member configured to apply an anti-vibration compression force on the sleeve to increase an engagement force between sleeve and the body assembly to reduce vibration in the chuck when the lock ring is in the locked position, wherein the anti-vibration compression force is not applied when the lock ring is in the unlocked position;
wherein, when the lock ring is in a locked position, rotation of the nut relative to the body assembly to move the jaws in the opening direction is prevented.

15. The chuck of claim 14, wherein the damping member comprises a damping arm that extends from a ring portion of the lock ring and out of a plane of a ring portion of the lock ring, the damping arm having a mechanical bias to urge the sleeve toward the body assembly when the lock ring is in the locked position.

16. The chuck of claim 14, wherein the damping member exhibits a damping mechanical bias directed in a forward direction towards a front of the chuck to urge the sleeve towards a nose lip of the body assembly.

17. The chuck of claim 14, wherein the sleeve comprises a damping surface ledge and a damping recess;
wherein, when the lock ring is in the locked position, the damping member is engaged with the damping surface ledge and applies the anti-vibration compression force onto the sleeve;
wherein, when the lock ring is in the unlocked position, the damping member is located within the damping recess such that the damping member does not apply the anti-vibration compression force onto the sleeve.

18. The chuck of claim 14, wherein the damping surface ledge and the damping recess are disposed on the sleeve.

19. A chuck comprising:
a body assembly;
a plurality of jaws, wherein the plurality of jaws rotate with the body assembly about a center axis of the chuck, wherein the plurality of jaws also move relative to the body assembly in an opening or closing direction;
a nut operably coupled to the jaws such that rotation of the nut relative to the body assembly moves the jaws relative to the body assembly in the opening or closing direction;
a sleeve; and
a lock ring operably coupled to the nut and the sleeve, the lock ring being coupled to the nut such that the lock ring and the nut rotate together, the lock ring being coupled to the sleeve such that the lock ring rotates relative to the sleeve when transitioning between a locked position and an unlocked position;
wherein the lock ring comprises a ring portion and a damping arm, the ring portion defining a ring portion plane, the damping arm extending from the ring portion at an angle such that an end of the damping arm is out of the ring portion plane;
wherein the damping arm exhibits a damping mechanical bias and the damping arm is configured to apply an anti-vibration compression force that is directed parallel to the center axis of the chuck, via the damping mechanical bias, on the sleeve to increase an engagement force between internal sleeve and the external sleeve to reduce vibration in the chuck when the lock ring is in the locked position, wherein the anti-vibration compression force is not applied when the lock ring is in the unlocked position;
wherein, when the lock ring is in a locked position, rotation of the nut relative to the body assembly to move the jaws in the opening direction is prevented.

20. The chuck of claim 19, wherein the sleeve comprises a damping surface ledge and a damping recess;
wherein, when the lock ring is in the locked position, the damping arm is engaged with the damping surface ledge and applies the anti-vibration compression force onto the sleeve;
wherein, when the lock ring is in the unlocked position, the damping arm is located within the damping recess such that the damping arm does not apply the anti-vibration compression force onto the sleeve.
